(19) United States
(12) Patent Application Publication
(10) Pub. No.: US 2010/0276621 A1
(43) Pub. Date: Nov. 4, 2010

(54) Butterfly valve

(76) Inventor: Johann Zwick, Ennepetal (DE)

Correspondence Address: COLLARD & ROE, P.C., 1077 NORTHERN BOULEVARD, ROSLYN, NY, 11576, US

(21) Appl. No.: 12/661,666

(22) Filed: Mar. 22, 2010

Related U.S. Application Data
(60) Provisional application No. 61/215,300, filed on May 4, 2009.

(51) Int. Cl. F16K 1/22

(52) U.S. Cl. 251/305

(57) ABSTRACT

A butterfly valve (1) for media under pressure includes a housing (2) having a passage (4) for the medium and a butterfly (6), which is positioned as a shut-off member within the passage (4). The butterfly (6) is pivotable by means of a shaft (10), which is rotatably mounted at two ends and extends transversely through the passage (4), about an axis of rotation (12) in such a manner that, in an open position, it is orientated with its disc plane approximately corresponding to the direction of the passage and in a shut-off position, lying transversely relative to the passage direction, interacts with a sealing seat (16) on the housing so as to provide a circumferential seal. The butterfly (6) is connected to the shaft (10) so as to be relatively displaceable in the transverse direction of the shaft in such a manner that in the shut-off position, by means of a further rotation of the shaft (10), the butterfly (6) is displaceable further against the sealing seat (16) relative to the axially-fixedly mounted shaft (10).

### CROSS REFERENCE TO RELATED APPLICATIONS

Applicant claims priority under 35 U.S.C. §119(e) of U.S. Provisional Patent Application Ser. No. 61/215,300 filed May 4, 2009.

### BACKGROUND OF THE INVENTION

1. Field of the Invention

According to the preamble of claim 1, the present invention relates to a butterfly valve for blocking off flow lines for arbitrary, i.e. gaseous or liquid media under pressure, said butterfly valve comprising a housing having a passage for the medium and a butterfly, which is positioned as a shut-off member within the passage and is pivotable by means of a shaft, which is rotatably mounted at two ends and extends transversely through the passage, about an axis of rotation in such a manner that in an open position, it is orientated with its disc plane approximately corresponding to the direction of the passage and in a shut-off position, lying transversely relative to the passage direction, interacts with a sealing seat on the housing so as to provide a circumferential seal.

2. Description of the Related Art

These types of butterfly valves are known, which is why the documents DE 298 22 791 U1 and EP 1 233 216 B1 and the corresponding U.S. Pat. No. 6,595,488 B2 are referred to. The valves described in these documents have proved their worth in practice. However, it has been shown that in particular when used in the low temperature range, such as, for example, in lines for liquid gases at temperatures around minus 180° to minus 200°, leaks can occur in the shut-off position.

### SUMMARY OF THE INVENTION

It is the object of the present invention to improve a butterfly valve of the aforementioned type such that, to a large extent regardless of the respective application, in particular even when used in the low temperature range, improved sealing can be ensured in the shut-off position.

This is achieved according to the invention through the features of claim 1. Advantageous development features can be found in the dependent claims and the subsequent description.

Thus, according to the invention, the butterfly is connected to the shaft so as to be relatively displaceable in the transverse direction of the shaft in such a manner that, in the shut-off position, by means of a further rotation of the shaft, the butterfly is displaceable further against the sealing seat relative to the axially-fixedly mounted shaft. This means that, in an advantageous manner, it is possible to compensate for material shrinkage that is caused by cold by it being possible to press the butterfly further against the—preferably conical—sealing seat.

### BRIEF DESCRIPTION OF THE DRAWINGS

The invention is described more accurately below by way of a preferred exemplary embodiment illustrated in the drawing, in which, in detail:

FIG. 1 is a front view of a butterfly valve according to the invention with its butterfly in the shut-off position and on its bearing side,

FIG. 2 is a part axial section in the section plane II-II in FIG. 1,

FIG. 3 is a part transverse section in the plane III-III in FIG. 1 with no representation of the shaft,

FIG. 4 is an enlarged representation as in FIG. 3 for further clarification of preferred development features,

FIG. 5 is a separate representation of the butterfly in a partial section in the direction of the axis of rotation of the shaft—the shaft is not represented in this case,

FIG. 6 is a top view of the butterfly in the direction of arrow VI in FIG. 5 leaving out certain individual parts,

FIG. 7 is an enlarged representation, rotated in the drawing plane, of the butterfly in FIG. 5, in a state corresponding to its open position,

FIG. 8 is a representation analogous to FIG. 7, but in a state corresponding to the shut-off position and

FIG. 9 is a detail enlargement from FIG. 8 for further clarification of the invention.

### DETAILED DESCRIPTION OF PREFERRED EMBODIMENTS

Identical parts in the various Figures of the drawing are always provided with identical references and consequently, as a rule, are only described once in each case.

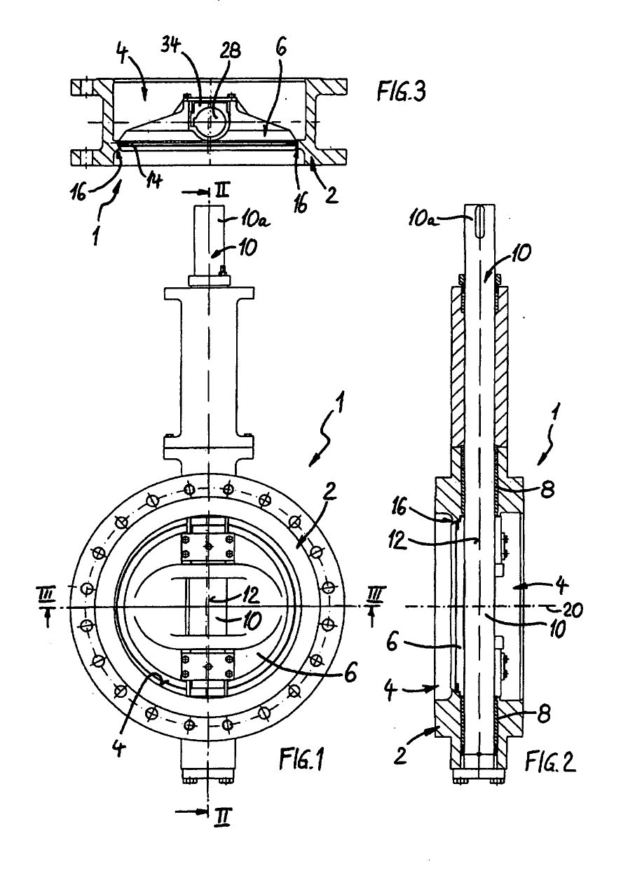

A butterfly valve 1 according to the invention comprises a substantially ring-shaped housing 2 with a passage 4 (see FIGS. 2 to 4) for a medium and a butterfly 6 that is positioned as shut-off member within the passage 4 and is substantially circular. Said butterfly 6 is rotatable, or more specifically pivotable by means of a shaft 10, which is positioned on one disc side, guided at two ends in pivot bearings 8 in the housing and extends transversely through the passage 4, about an axis of rotation 12 that extends transversely with respect to the circular shape of the disc in such a manner that, in an open position (not represented in the drawing), it extends with its disc plane approximately corresponding to the direction of the passage or approximately parallel thereto and, in the shut-off position represented respectively in FIGS. 1 to 4, sealing the passage 4 with an outer circumferential sealing element 14, interacts in a sealing manner with a circumferential sealing seat 16 on the housing. The shaft 10 is guided at one end out of the housing 2 towards the outside with an actuating end 10a so that the butterfly 6 can be displaced via the shaft 10 by means of a suitable drive element (not represented).

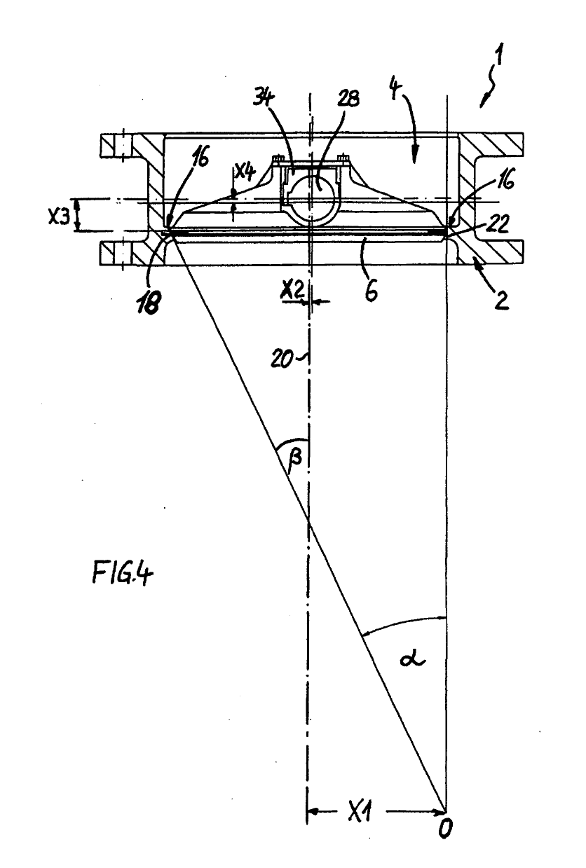

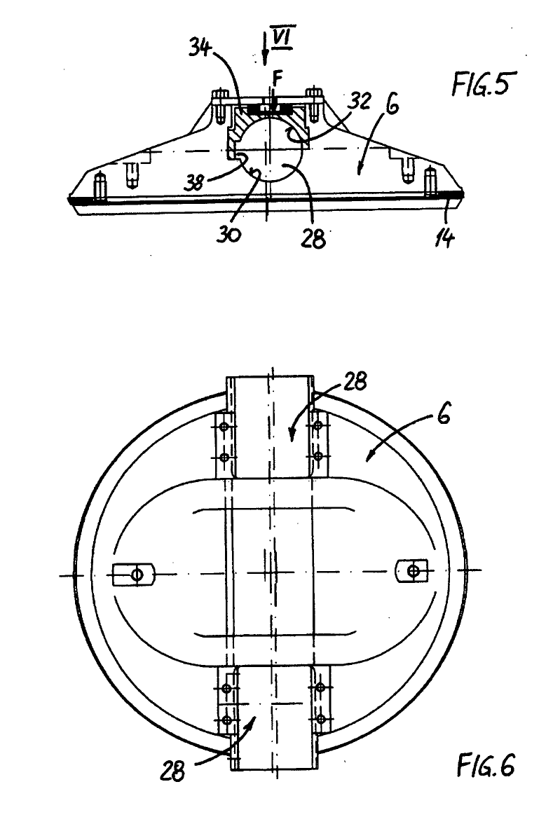

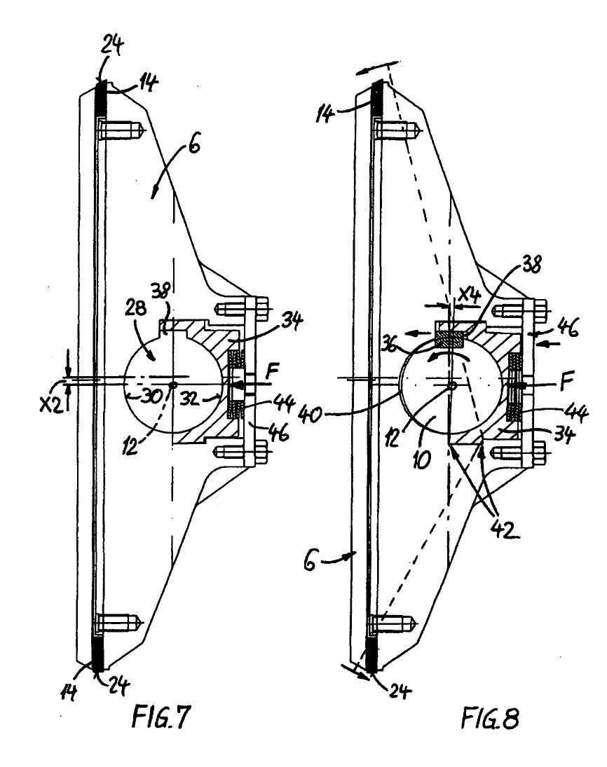

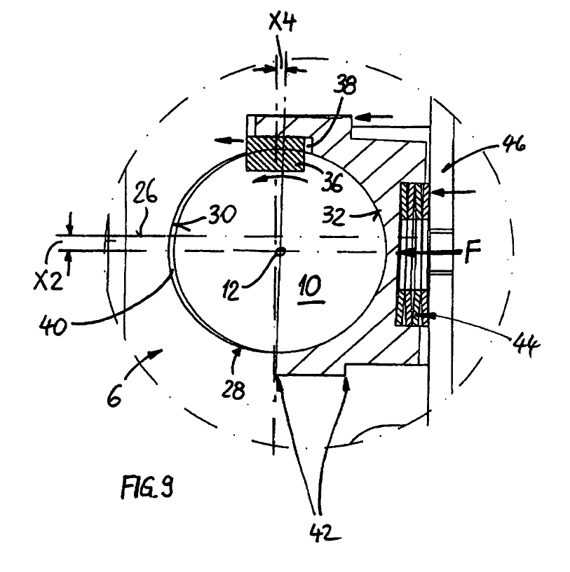

As is known in principle in the case of these types of butterfly valves, a “triple eccentric” development is provided for good sealing. This is explained especially by way of FIG. 4. Accordingly, the sealing seat 16 of the housing 2 is initially realized as a conical surface 18 that reduces in diameter in the closing direction of the butterfly 6 at a cone angle α, the cone angle α or its point of origin 0 being offset in an eccentric manner relative to the longitudinal centre axis 20 of the passage 4 in such a manner that the conical surface 18, at a circumferential point, has a straight surface zone 22, which extends substantially parallel to the direction of the passage—and consequently vertically relative to the plane of the passage opening. On the side situated diametrically opposite to said straight surface zone 22, the conical surface 18 is at a maximum angle β to the longitudinal centre axis 20, and over the remaining circumferential regions the angle between the conical surface 18 and the longitudinal centre axis 20 changes continuously between zero and the maximum angle β. This “first eccentricity” of the conical surface 18 is illustrated in FIG. 4 by X1. As can be seen in particular in FIGS. 7 and 8, the sealing element 14 of the butterfly 6 has a conical surface 24 correspondingly adapted to the conical surface 18. The straight surface zone 22 can also be identified as a “90° side” because the conical surface 18 in this case forms a right angle with the closing plane of the butterfly 6 or with the opening plane of the passage 4. The “90° side” with the straight surface zone 22 of the sealing seat 16 rests on an axis of the opening plane that is at right angles to the axis of rotation 12, such that, when pivoting into the shut-off position, the butterfly 6 is pressed with the sealing element 14 approximately radially against the surface zone 22.

As the “second eccentricity” it is provided that the axis of rotation 12 of the shaft 10 is offset by an offset X2 relative to the longitudinal centre axis 26 of the butterfly 6, and in particular in the direction of the straight surface zone 22 of the sealing seat 16 or of the region of the sealing element 14 of the butterfly 6 adapted to the surface zone 22; see also in this respect FIG. 7. The longitudinal centre axis 20 of the passage 4 and the longitudinal centre axis 26 of the butterfly 6 preferably coincide in the shut-off position.

As can also be seen in FIG. 4, as “third eccentricity” it is provided that the axis of rotation 12 of the shaft 10 is positioned offset in the direction of the passage relative to the sealing plane defined by the sealing seat 16, especially into the direction in which the conical surface 18 of the sealing seat 16 widens in diameter. This offset is marked in FIG. 4 by X3.

It is additionally provided according to the invention that the butterfly 6 is connected to the shaft 10 so as to be relatively displaceable in the transverse direction of the shaft in such a manner that in the shut-off position, by means of a further rotation of the shaft 10 in the closing direction, the butterfly 6 is displaceable further against the sealing seat 16 relative to the axially-fixedly mounted shaft 10. In practice, this is an additional movement in a “fourth axis”, which is illustrated in FIGS. 4, 8 and 9 by X4.

Structurally, it is provided in a preferred manner that the shaft 10 extends through two similar type bearing openings 28 of the butterfly 6 that are spaced apart in the longitudinal direction of the shaft. Each bearing opening 28 is formed proportionately by a bearing shell 30 of the butterfly 6 and by a bearing shell 32 of a separate bearing pressure piece 34. Each bearing pressure piece 34 is positioned on the side pointing away from the sealing seat 16 and is impinged upon by a spring force F acting in the direction of the shaft 10. The spring force F is dimensioned such that, in its unloaded state in the open position, the butterfly 6 is retained on the shaft 10 substantially free from play. In the region of each bearing opening 28 at a circumferential point, the shaft 10 has a radially protruding entrainment element 36, which engages an entrainment recess 38 formed within the respective bearing opening 28 between the bearing shells 30, 32 of the butterfly 6 and of the bearing pressure piece 34, in such a manner that at the one end the butterfly 6 is connected to the shaft 10 in a torque-setting manner, and that at the other end in the shut-off position, by means of the entrainment element 36, the butterfly 6 is displaceable in opposition to the spring force F away from the shaft 10 and the bearing pressure piece 34. On account of the arrangement of the entrainment element 36 on only one circumferential side of the shaft 10, this movement of the butterfly 6 is a pivotal movement away from the shaft 10, a gap 40 being created between the side of the shaft 10 situated opposite the bearing pressure piece 34 and the bearing shell 30 of the butterfly 6; see FIGS. 8 and 9 in this respect. The entrainment element 36 is preferably positioned on that side of the shaft 10, which—with reference to the shut-off position—points in the direction situated diametrically opposite to the straight surface zone 22 of the sealing seat 16. Between the butterfly 6 and the bearing pressure piece 34, on the one hand, on the side of the entrainment element 36, a displacement clearance is formed for the described relative displacement and on the other hand, on the side situated approximately diametrically opposite, a stop member 42 acting as a tipping axis is formed. It is additionally illustrated in FIGS. 8 and 9 by way of marked arrows that the afore-described relative (tipping) movement between butterfly 6 and shaft 10 is effected by means of a further rotation of the shaft 10, the outer circumferential sealing zone of the butterfly 6 pressing further against the sealing seat 16 in the direction of the other arrows shown. As a rule, a displacement clearance of a few mm in the region of the entrainment element 36 is sufficient here.

When opening the valve 1, proceeding from the shut-off position, reverse rotating the shaft 10 first of all moves the butterfly 6 with the bearing shell 30 back against the shaft 10 by means of the spring force F, and the butterfly 6 is then pivoted into the open position.

A so-called splined key or wedge element can be provided as entrainment element 36, the entrainment element 36 resting in a proportionate manner in a groove-like recess in the shaft 10 and in the entrainment recess 38 between the butterfly 6 and the bearing pressure piece 34.

The spring force F impinging upon the bearing pressure piece 34 can be generated by a resilient element 44, which rests in a prestressed manner between the bearing pressure piece 34 and a thrust bearing 46 that is connected fixedly to the butterfly 6. In an advantageous manner, the resilient element 44 can be realized as a laminated cup spring. The spring force F can be within the range of 10,000 to 15,000 N, for example, with the valve open about 12,500 N and with the valve close about 15,000 N.

From the outside periphery of the butterfly 6, each bearing pressure piece 34 can be slid parallel to the disc plane into a receiving means of the butterfly 6. A sliding connection in the manner of a dovetail joint or a T connection is possible here.

The invention is not restricted to the exemplary embodiments represented and described, but includes all embodiments that are equally acting within the sense of the invention. In addition, the invention is not restricted to the feature combinations defined so far in the independent claims but can be defined by any other arbitrary combination of specific features from all the individual features disclosed overall. This means that in principle practically every individual feature of the independent claim can be omitted or replaced by at least one individual feature disclosed elsewhere in the application. In this respect, the claims are simply to be understood as a first attempt at verbalizing an invention.

1. A butterfly valve (1) for media under pressure, said butterfly valve comprising a housing (2) having a passage (4) for the medium and a butterfly (6), which is positioned as a shut-off member within the passage (4) and is pivotable by means of a shaft (10), which is rotatably mounted at two ends and extends transversely through the passage (4), about an axis of rotation (12) in such a manner that in an open position, it is orientated with its disc plane approximately corresponding to the direction of the passage and in a shut-off position, lying transversely relative to the passage direction, interacts with a sealing seat (16) on the housing so as to provide a circumferential seal, wherein the butterfly (6) is connected to the shaft (10) so as to be relatively displaceable in the transverse direction of the shaft in such a manner that in the shut-off position, by means of a further rotation of the shaft (10), the butterfly (6) is displaceable further against the sealing seat (16) relative to the axially-fixedly mounted shaft (10).

2. The butterfly valve as claimed in claim 1, wherein the shaft (10) extends through at least one bearing opening (28) of the butterfly (6), preferably through two similar type bearing openings (28) that are spaced apart in the longitudinal direction of the shaft, wherein the/every bearing opening (28) is formed proportionately by a bearing shell (30) of the butterfly (6) and a bearing shell (32) of a separate bearing pressure piece (34), wherein the bearing pressure piece (34) is positioned on the side pointing away from the sealing seat (16) and is impinged upon by a spring force (F) acting in the direction of the shaft (10).

3. The butterfly valve as claimed in claim 2, wherein at a circumferential point the shaft (10) has a radially protruding entrainment element (36), which engages an entrainment recess (38) formed within the bearing opening (28) between the bearing shells (30, 32) of the butterfly (6) and of the bearing pressure piece (34) in such a manner that at one end the butterfly (6) is connected to the shaft (10) in a torque-setting manner, and that at the other end in the shut-off position, by means of the entrainment element (36), the butterfly (6) is displaceable in opposition to the spring force (F) away from the shaft (10) and the bearing pressure piece (34) against the sealing seat (16).

4. The butterfly valve as claimed in claim 1, wherein the sealing seat (16) of the housing (2) is realized as a conical surface (18) reducing in diameter in the closing direction at a cone angle (α), wherein the cone angle (α) is realized in an eccentric manner relative to the longitudinal center axis (20) of the passage (4) in such a manner that the conical surface (18) has a straight surface zone (22) that extends substantially parallel to the direction of the passage at a circumferential point of the sealing seat (16).

5. The butterfly valve as claimed in claim 1, wherein the axis of rotation (12) of the shaft (10) is offset in an eccentric manner relative to the longitudinal center axis (26) of the butterfly (6), in particular in the direction of the straight surface zone (22) of the sealing seat (16).

6. The butterfly valve as claimed in claim 1, wherein the axis of rotation (12) of the shaft (10) is positioned offset in the direction of the passage relative to a sealing plane defined by the sealing seat (16).

7. The butterfly valve as claimed in claim 3, wherein the entrainment element (36) is positioned on the side of the shaft (10), which points in the direction situated diametrically opposite the straight surface zone (22) of the sealing seat (16).

8. The butterfly valve as claimed in claim 3, wherein between the butterfly (6) and the bearing pressure piece (34) at the one end on the side of the entrainment element (36), a displacement clearance is formed for the relative displacement and at the other end on the approximately diametrically opposite side a stop member (42) acting as a tipping axis is formed.

9. The butterfly valve as claimed in claim 2, wherein the spring force (F) impinging upon the bearing pressure piece (34) is generated by a resilient element (44) which rests in a prestressed manner between the bearing pressure piece (34) and a thrust bearing (46) that is connected fixedly to the butterfly (6), wherein the resilient element (44) is realized in particular as a laminated cup spring.
